(19) United States
(12) Patent Application Publication
(10) Pub. No.: US 2025/0051484 A1
(43) Pub. Date: Feb. 13, 2025

(54) HEAT-RESISTANT RESISTANT STARCH (RS) AND PREPARATION METHOD THEREOF

(71) Applicant: Qingdao Agricultural University, Qingdao City (CN)

(72) Inventors: Qingjie Sun, Qingdao City (CN); Liyang Zhou, Qingdao City (CN); Liu Xiong, Qingdao City (CN); Yang Qin, Qingdao City (CN); Mingju Li, Qingdao City (CN)

(21) Appl. No.: 18/425,400

(22) Filed: Jan. 29, 2024

(30) Foreign Application Priority Data
Aug. 7, 2023 (CN) 202310979630.7

(51) Int. Cl. C08B 31/00

(52) U.S. Cl. CPC C08B 31/00

(57) ABSTRACT

The present disclosure provides a heat-resistant resistant starch (RS) and a preparation method thereof, and belongs to the technical field of food processing. The preparation method includes: preparing a short chain glucan (SCG) into a SCG mixed dispersion with a mass volume concentration of 20% to 100%, and conducting gelatinization to obtain a transparent SCG molecule solution; naturally cooling the transparent SCG molecule solution to allow recrystallization until the transparent SCG molecule solution is cooled to room temperature to obtain a crystallized starch; and freeze-drying the crystallized starch to obtain the heat-resistant RS. The preparation method is green during an entire process and does not involve any organic solvent, thus achieving a breakthrough in the simple and efficient preparation of a heat-resistant high-crystallized starch with a high yield and small particles. In the present disclosure, the heat-resistant RS has higher thermal stability, relative crystallinity, and RS content.

### CROSS REFERENCE TO RELATED APPLICATION

This patent application claims the benefit and priority of Chinese Patent Application No. 202310979630.7, filed with the China National Intellectual Property Administration on Aug. 7, 2023, the disclosure of which is incorporated by reference herein in its entirety as part of the present application.

### TECHNICAL FIELD

The present disclosure belongs to the technical field of food processing, and in particular relates to a heat-resistant resistant starch (RS) and a preparation method thereof.

### BACKGROUND

Resistant starch (RS) has been proved to have potential physiological benefits against obesity, diabetes, colon cancer, and cardiovascular diseases, and exhibits similar functions to those of soluble dietary fibers. The RS can be divided into 5 categories: RS1, physically-embedded starch; RS2, RS granules; RS3, retrograded starch; RS4, chemically-modified starch; and RS5, amylose-lipid complexes. RS3-type RS is an interesting and unique RS due to its thermal stability. Mainly heat and moisture are involved in promoting the formation of the RS3-type RS. Since amylose molecules have a strong tendency to rearrange, RS3 is primarily aged/recrystallized starch.

Currently, the most commonly-used method to increase a content of the RS3-type RS is the debranching of a gelatinized starch by amylase enzymes (such as isoamylase and pullulanase), which can result in the reorganization of short chain glucan (SCG) molecules. Many researchers have also studied various approaches to increase the RS content of starch. Waxy corn starch can be debranched and recrystallized to obtain slowly digestible starch (SDS) and the RS. The above studies have mainly explored an effect of starch debranching conditions (such as a number of the debranching and recrystallization, as well as a concentration of the pullulanase) on the formation of RS. Tapioca starch and waxy starch can be debranched and recrystallized by pullulanase and then further treated with hydrothermal treatment to increase their RS content. Lehmann et al. reported that banana starch has a RS content as high as 84% after debranching, aging, and hydrothermal treatment. Another study has showed that the RS content of debranched rice starch is increased after hydrothermal treatment. It can be seen that enzymatic debranching and hydrothermal treatment are considered to be green, safe, and economical processes and have important contributions to the formation of RS. However, a method of enriching SCG by centrifugal separation has not been reported yet.

In addition, studies have found that a degree of polymerization (DP) of the amylose has been confirmed to affect the formation of RS. An appropriate chain length is necessary for starch crystallization and double helix formation, and is also beneficial to the RS formation. However, the SCG is a mixture of short linear chain glucans with different DPs, which may not form a double helix to produce crystals or contribute to RS resistance, resulting in a reduction in the RS content. There have been no reports on the formation of heat-resistant RS3 by adjusting the concentration of SCG so far.

### SUMMARY

In view of this, an objective of the present disclosure is to provide a heat-resistant resistant starch (RS) and a preparation method thereof. The heat-resistant RS prepared by the preparation method has both high content and crystallinity.

To achieve the above objective, the present disclosure provides the following technical solutions:

The present disclosure provides a preparation method of a heat-resistant RS, including the following steps:
preparing a SCG into a SCG mixed dispersion with a mass volume concentration of 20% to 100%, and conducting gelatinization to obtain a transparent SCG molecule solution; naturally cooling the transparent SCG molecule solution to allow recrystallization until the transparent SCG molecule solution is cooled to room temperature to obtain a crystallized starch; and freeze-drying the crystallized starch to obtain the heat-resistant RS.

Preferably, a solvent of the SCG mixed dispersion is water.

Preferably, the gelatinization is conducted at 100° C. to 120° C. for 1 min to 30 min.

Preferably, a preparation process of the SCG includes the following steps:
(1) stirring a starch milk with a mass volume concentration of 10% to 20% to allow gelatinization to obtain a starch paste;
(2) mixing the starch paste with an enzyme to allow enzymatic debranching to obtain an enzymatic mixture;
(3) subjecting the enzymatic mixture to first centrifugation at 3,000 rpm to 4,000 rpm for 0.5 min to 1.5 min to obtain a supernatant 1, subjecting the supernatant 1 to enzyme deactivation to obtain an enzyme-deactivated mixture, and subjecting the enzyme-deactivated mixture to second centrifugation at 3,000 rpm to 4,000 rpm for 0.5 min to 1.5 min to obtain a supernatant 2; and
(4) subjecting the supernatant 2 to recrystallization and retrogradation at 2° C. to 6° C. for 8 h to 16 h, centrifuging to discard a resulting supernatant, and then drying a remaining product to obtain the SCG.

Preferably, the gelatinization in step (1) is conducted at 95° C. to 125° C. for 25 min to 35 min.

Preferably, the starch milk in step (1) has a pH value of 4.5 to 5.0; and the starch milk is prepared by dispersing a starch in a phosphate-buffered saline (PBS).

Preferably, the enzyme in step (2) is selected from the group consisting of pullulanase and isoamylase; the enzyme has an activity of 6,000 new pullulanase unit novozymes (NPUN) to 7,000 NPUN; the starch paste and the enzyme are at a mass-to-volume ratio of 100 g: (1-5) mL; and the enzymatic debranching is conducted at 50° C. to 60° C. for 22 h to 26 h.

Preferably, the first centrifugation and the second centrifugation in step (4) each are conducted at 4,000 rpm to 6,000 rpm for 5 min to 15 min.

Preferably, the starch is one or more selected from the group consisting of a waxy corn starch, a common corn starch, a potato starch, a pea starch, and a tapioca starch.

The present disclosure further provides a heat-resistant RS prepared by the preparation method.

Compared with the prior art, the present disclosure has the following beneficial effects:

The present disclosure provides a heat-resistant RS and a preparation method thereof. The preparation method is green during an entire process and does not involve any organic solvent, thus achieving a breakthrough in the simple and efficient preparation of a heat-resistant high-crystallized starch with a high yield and small particles. In the present disclosure, a concentration of the SCG is studied on recrystallization of the SCG in preparing RS3. It is found that compared with original SCG and 5% to 15% SCG, the crystallized starch obtained by gelatinization and recrystallization of 20% to 100% SCG has higher thermal stability (Tₚ: 114.72° C. to 115.77° C.), higher relative crystallinity (73.64%), and higher RS content (63.93% to 72.08%). The heat-resistant RS (also known as crystallized starch) has a gelatinization temperature exceeding 100° C. and reaching 115° C., thereby achieving heat resistance to 100° C. hydrothermal cooking, achieving resistance to cooking, and still retaining a crystalline structure. The preparation method is a “green and clean” method in terms of preparing RS3, increasing RS3 content, and improving functional properties of SCG. The present disclosure realizes the commercial production of stable high-content RS, and can open up a new field and new direction in the nutrition science with RS as the staple food and diet.

### BRIEF DESCRIPTION OF THE DRAWINGS

FIGS. 1A-H show scanning electron microscopy (SEM) images of different samples, where A: SEM image of SCG (denoted as SCG) prepared in Example 1; B: SEM image of SCG-5%; C: SEM image of SCG-10%; D: SEM image of SCG-15%; E: SEM image of SCG-20%; F: SEM image of SCG-30%; G: SEM image of SCG-40%; and H: SEM image of SCG-50%;

FIG. 2 shows X-ray diffraction (XRD) patterns of original SCG and crystallized starch samples (SCG-5%, SCG-10%, SCG-15%, SCG-20%, SCG-30%, SCG-40%, and SCG-50%) obtained at different concentrations;

FIG. 3 shows infrared spectrograms of original SCG and crystallized starch samples (SCG-5%, SCG-10%, SCG-15%, SCG-20%, SCG-30%, SCG-40%, and SCG-50%) obtained at different concentrations;

FIG. 4 shows Raman spectrograms of original SCG and crystallized starch samples (SCG-5%, SCG-10%, SCG-15%, SCG-20%, SCG-30%, SCG-40%, and SCG-50%) obtained at different concentrations; and

FIG. 5 shows a flow chart of a preparation process of the heat-resistant RS.

### DETAILED DESCRIPTION OF THE EMBODIMENTS

The present disclosure provides a preparation method of a heat-resistant RS, including the following steps:

preparing a SCG into a SCG mixed dispersion with a mass volume concentration of 20% to 100%, and conducting gelatinization to obtain a transparent SCG molecule solution; naturally cooling the transparent SCG molecule solution to allow recrystallization until the transparent SCG molecule solution is cooled to room temperature to obtain a crystallized starch; and freeze-drying the crystallized starch to obtain the heat-resistant RS.

In the present disclosure, a SCG is prepared into a SCG mixed dispersion with a mass volume concentration of 20% to 100%, and gelatinization is conducted to obtain a transparent SCG molecule solution; the transparent SCG molecule solution is naturally cooled to allow recrystallization until the transparent SCG molecule solution is cooled to room temperature to obtain a crystallized starch; and the crystallized starch is freeze-dried to obtain the heat-resistant RS. The SCG mixed dispersion has a concentration of preferably 30% to 90%, more preferably 40% to 80%. A solvent of the SCG mixed dispersion is preferably water. The gelatinization is conducted at preferably 100° C. to 120° C. for preferably 1 min to 30 min; the gelatinization can be microwave gelatinization or high-temperature and high-pressure gelatinization, such as the microwave gelatinization for 1 min or the high-temperature and high-pressure gelatinization for 30 min to achieve full gelatinization. The gelatinization destroys an original crystal structure of the SCG and induces the formation of new crystals, thereby improving a regularity of the crystals and promoting the formation of RS. The gelatinization and recrystallization of the SCG are easy and fast to operate and can be completed within 30 min, with a yield as high as 100%.

In the present disclosure, a preparation process of the SCG preferably includes the following steps:
(1) stirring a starch milk with a mass volume concentration of 10% to 20% to allow gelatinization to obtain a starch paste;
(2) mixing the starch paste with an enzyme to allow enzymatic debranching to obtain an enzymatic mixture;
(3) subjecting the enzymatic mixture to first centrifugation at 3,000 rpm to 4,000 rpm for 0.5 min to 1.5 min to obtain a supernatant 1, subjecting the supernatant 1 to enzyme deactivation to obtain an enzyme-deactivated mixture, and subjecting the enzyme-deactivated mixture to second centrifugation at 3,000 rpm to 4,000 rpm for 0.5 min to 1.5 min to obtain a supernatant 2; and
(4) subjecting the supernatant 2 to recrystallization and retrogradation at 2° C. to 6° C. for 8 h to 16 h, centrifuging to discard a resulting supernatant, and then drying a remaining product to obtain the SCG.

In the present disclosure, a starch milk with a mass volume concentration of 10% to 20% is stirred to allow gelatinization to obtain a starch paste. Preferably, the starch milk is prepared by dispersing a starch in a PBS. For example, a preparation process of a 10% to 20% starch milk includes dispersing 10 g to 20 g of the starch in 100 mL of the PBS. The starch milk has a pH value of preferably 4.5 to 5.0. The gelatinization is conducted for preferably 25 min to 35 min, more preferably 27 min to 33 min at preferably 95° C. to 125° C., more preferably 100° C. to 120° C. There is no particular limitation on a source of the PBS, which can be products commercially available in the field or prepared using conventional preparation methods.

In the present disclosure, the starch paste is mixed with an enzyme to allow enzymatic debranching to obtain an enzymatic mixture. The enzyme is preferably selected from the group consisting of pullulanase and isoamylase; the enzyme has an activity of 6,000 NPUN to 7,000 NPUN; and the starch paste and the enzyme are at a mass-to-volume ratio of 100 g: (1-5) mL. The enzymatic debranching is conducted at 50° C. to 60° C., more preferably 52° C. to 58° C. for 22 h to 26 h, more preferably 23 h to 25 h.

In the present disclosure, the enzymatic mixture is subjected to first centrifugation at 3,000 rpm to 4,000 rpm for 0.5 min to 1.5 min to obtain a supernatant 1, the supernatant 1 is subjected to enzyme deactivation to obtain an enzyme-deactivated mixture, and the enzyme-deactivated mixture is subjected to second centrifugation at 3,000 rpm to 4,000 rpm for 0.5 min to 1.5 min to obtain a supernatant 2. The enzymatic mixture can be centrifuged to enrich the SCG in large amounts.

In the present disclosure, the supernatant 2 is subjected to recrystallization and retrogradation at 2° C. to 6° C. for 8 h to 16 h, a resulting supernatant is discarded by centrifuging, and then a remaining product is dried to obtain the SCG. Preferably, the recrystallization and retrogeneration are conducted for 10 h to 14 h. The first centrifugation and the second centrifugation each are conducted at preferably 4,000 rpm to 6,000 rpm, more preferably 4,500 rpm to 5,500 rpm for preferably 5 min to 15 min, more preferably 7 min to 12 min. The drying preferably includes freeze-drying or oven drying, such as oven drying at 45° C. to 55° C.

In the present disclosure, the starch is preferably one or more selected from the group consisting of a waxy corn starch, a common corn starch, a potato starch, a pea starch, and a tapioca starch.

The present disclosure further provides a heat-resistant RS prepared by the preparation method.

In the present disclosure, the heat-resistant RS has higher thermal stability, relative crystallinity, and RS content.

The technical solution provided by the present disclosure will be described in detail below with reference to the examples, but they should not be construed as limiting the claimed scope of the present disclosure.

### EXAMPLE 1

A preparation method of a heat-resistant RS included the following steps:
(1) 15 g of a waxy corn starch was dispersed into 100 mL of PBS with pH=4.6, and gelatinized continuously by stirring in a boiling water bath for 30 min to obtain a completely gelatinized starch paste. The completely gelatinized starch paste was cooled to 58° C., 2.5 mL of 6,692 NPUN pullulanase was added to per 100 g of the starch paste, and then hydrolyzed at 58° C. for 24 h to obtain an enzymatic mixture. The enzymatic mixture was centrifuged at 3,500 rpm for 1 min, and a supernatant 1 rich in free SCG (denoted as SCG) molecules was collected; and the supernatant 1 was heated in a boiling water bath for 20 min to terminate the enzymatic reaction to obtain an enzyme-deactivated mixture. The enzyme-deactivated mixture was centrifuged at 3,500 rpm for 1 min to remove a denatured pullulanase precipitate to obtain a supernatant 2; the supernatant 2 was placed at 4° C. to allow recrystallization and retrogradation for 12 h to obtain a recrystallized starch; the recrystallized starch was centrifuged at 5,000 rpm for 10 min, and a resulting supernatant was discarded to obtain a precipitate a; and the precipitate a was dried in an oven at 50° C. to obtain a SCG (SCG).
(2) Preparation of a 20% SCG mixed dispersion: 20 g of the SCG prepared in step (1) was mixed with 100 ml of water to obtain the 20% SCG mixed dispersion.
(3) The 20% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-20%.

### EXAMPLE 2

This example differed from Example 1 in that: step (2) preparation of a 30% SCG mixed dispersion: 30 g of the SCG prepared in step (1) was mixed with 100 ml of water to obtain the 30% SCG mixed dispersion; (3) the 30% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-30%; while other steps were the same as those in Example 1.

### EXAMPLE 3

This example differed from Example 1 in that: step (2) preparation of a 40% SCG mixed dispersion: 40 g of the SCG prepared in step (1) was mixed with 100 ml of water to obtain the 40% SCG mixed dispersion; (3) the 40% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-40%; while other steps were the same as those in Example 1.

### EXAMPLE 4

This example differed from Example 1 in that: step (2) preparation of a 50% SCG mixed dispersion: 50 g of the SCG prepared in step (1) was mixed with 100 ml of water to obtain the 50% SCG mixed dispersion; (3) the 50% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-50%; while other steps were the same as those in Example 1.

### EXAMPLE 5

This example differed from Example 1 in that: step (2) preparation of a 70% SCG mixed dispersion: 70 g of the SCG prepared in step (1) was mixed with 100 ml of water to obtain the 70% SCG mixed dispersion; (3) the 70% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-70%; while other steps were the same as those in Example 1.

### EXAMPLE 6

This example differed from Example 1 in that: step (2) preparation of a 100% SCG mixed dispersion: 100 g of the SCG prepared in step (1) was mixed with 100 mL of water to obtain the 100% SCG mixed dispersion; (3) the 100% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-100%; while other steps were the same as those in Example 1.

### EXAMPLE 7

This example differed from Example 1 in that: 10 g of the waxy corn starch was used in this example, while the remaining steps were the same as those in Example 1.

### EXAMPLE 8

This example differed from Example 1 in that: 20 g of the waxy corn starch was used in this example, while the remaining steps were the same as those in Example 1.

### EXAMPLE 9

This example differed from Example 1 in that: 15 g of the common corn starch was used in this example, while the remaining steps were the same as those in Example 1.

### EXAMPLE 10

This example differed from Example 1 in that: 15 g of the tapioca starch was used in this example, while the remaining steps were the same as those in Example 1.

### EXAMPLE 11

This example differed from Example 1 in that: 15 g of the pea starch was used in this example, while the remaining steps were the same as those in Example 1.

### EXAMPLE 12

This example differed from Example 1 in that: 15 g of the potato starch was used in this example, while the remaining steps were the same as those in Example 1.

### Comparative Example 1

This comparative example differed from Example 1 in that: step (2) preparation of a 5% SCG mixed dispersion: 5 g of the SCG prepared in step (1) was mixed with 100 ml of water to obtain the 5% SCG mixed dispersion; (3) the 5% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-5%; while other steps were the same as those in Example 1.

### Comparative Example 2

This comparative example differed from Example 1 in that: step (2) preparation of a 10% SCG mixed dispersion: 10 g of the SCG prepared in step (1) was mixed with 100 ml of water to obtain the 10% SCG mixed dispersion; (3) the 10% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-10%; while other steps were the same as those in Example 1.

### Comparative Example 3

This comparative example differed from Example 1 in that: step (2) preparation of a 15% SCG mixed dispersion: 15 g of the SCG prepared in step (1) was mixed with 100 ml of water to obtain the 15% SCG mixed dispersion; (3) the 15% SCG mixed dispersion obtained in step (2) was sealed and heated in a microwave oven for 1 min at 120° C. to allow full gelatinization to obtain a transparent SCG molecule solution; the transparent SCG molecule solution was naturally cooled to allow recrystallization until the transparent SCG molecule solution was cooled to room temperature to obtain a crystallized starch; and the crystallized starch was freeze-dried to obtain the heat-resistant RS, which was named SCG-15%; while other steps were the same as those in Example 1.

### Test Example 1

In this test example, SCG (SCG, also known as original SCG) prepared in step (1) of Example 1, SCG-20% prepared in Example 1, SCG-30% prepared in Example 2, SCG-40% prepared in Example 3, SCG-50% prepared in Example 4, SCG-5% prepared in Comparative Example 1, SCG-10% prepared in Comparative Example 2, and SCG-15% prepared in Comparative Example 3 were subjected to SEM morphology measurement, XRD measurement, Fourier transform infrared spectroscopy measurement, Raman spectroscopy measurement, differential scanning calorimeter (DSC) measurement, and simulated in vitro digestion test.

Numerical statistical analysis: all samples were tested in parallel at least three times, and the results were averaged. Measurement data were statistically analyzed using SPSS 17.0 (SPSS Inc, Chicago, USA) and expressed as mean±standard deviation. To determine statistical significance, analysis of variance was conducted with Duncan's range test at the 0.05 (p<0.05) level, and ORIGIN version 2023 was used for plotting analysis.

### (1) SEM Morphology Measurement

The morphology of the samples SCG, SCG-5%, SCG-10%, SCG-15%, SCG-20%, SCG-30%, SCG-40%, and SCG-50% was observed under an accelerating voltage of 5 kV using JSM-IT500 SEM (Japan Electronic Instruments Co., Ltd.).

In order to study the effect of SCG concentration changes on the morphology of crystallized starch formed by SCG, the morphology of crystallized starch obtained after gelatinization and recrystallization at different concentrations was measured by SEM.

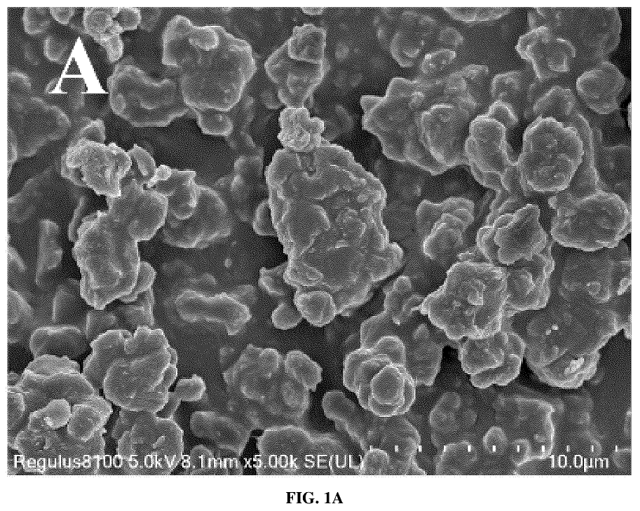

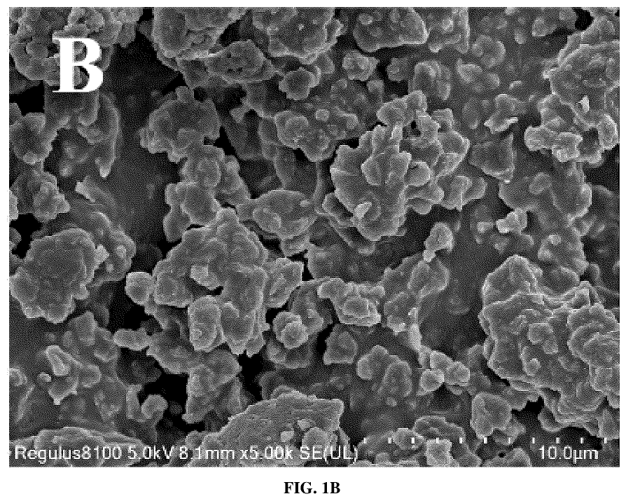

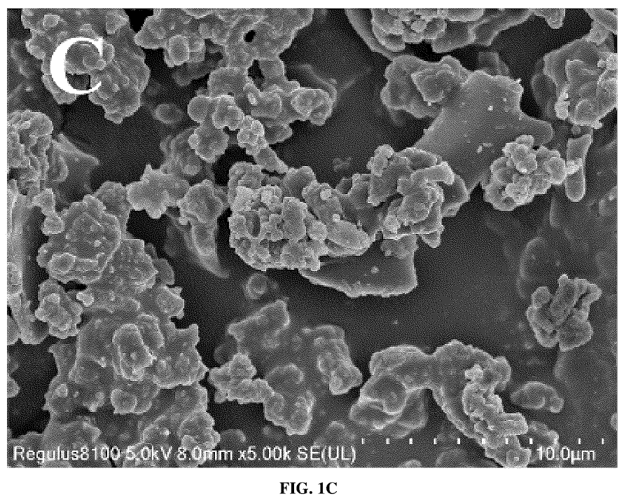

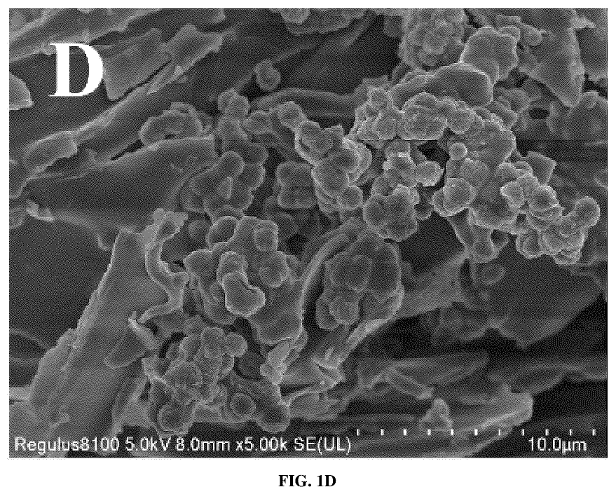

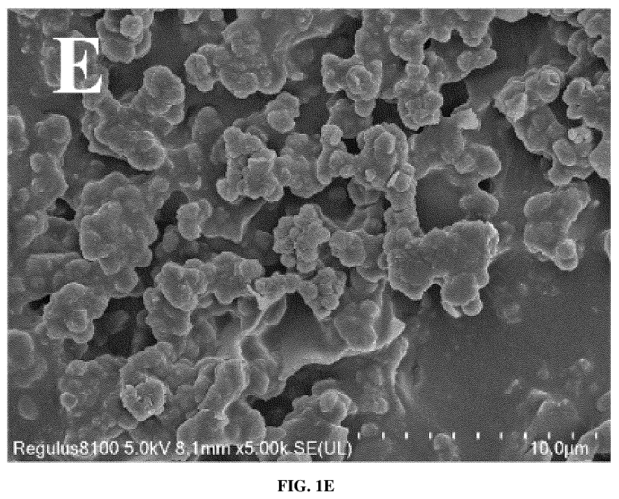

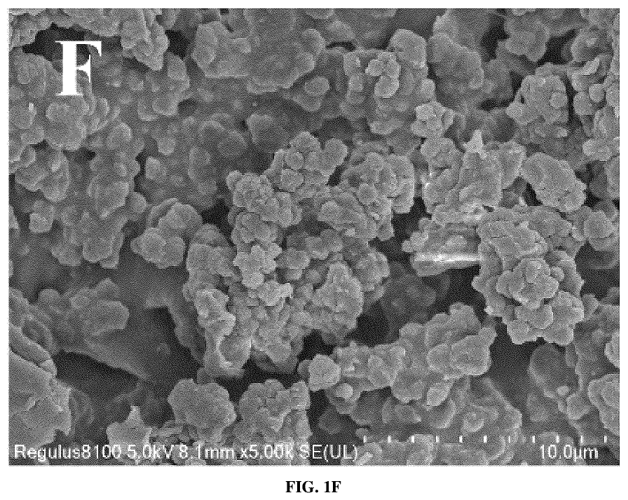

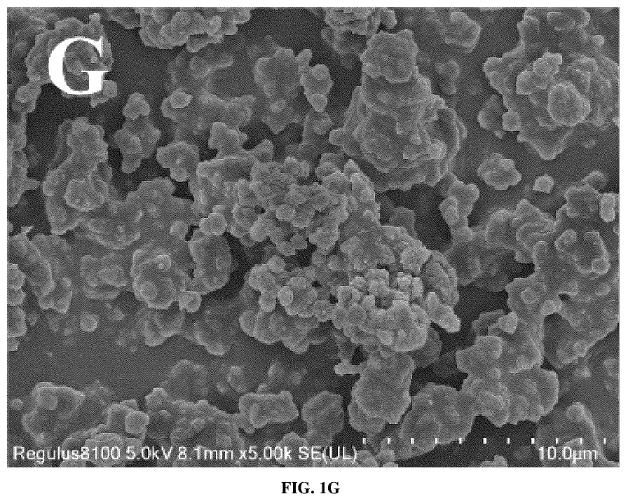

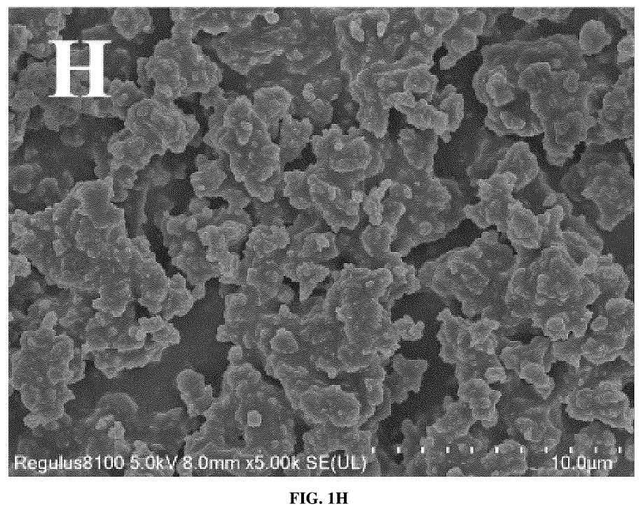

As shown in FIGS. 1A-H, the original SCG presented relatively large particle aggregates with irregular particle morphology and a size larger than 1 μm (FIG. 1A). When different concentrations of SCG were gelatinized and recrystallized, they could form a uniform spherical particle structure (FIGS. 1B to 1H) and also exhibited particle aggregation. The size differences between crystallized starch granules prepared at different SCG concentrations indicated that their reformation involved processes of nucleation, growth, and aggregation. As the crystallization concentration increased from 5% to 50%, the size of the crystallized starch particles obtained decreased accordingly, forming large particles or aggregates in some cases. As the recrystallization concentration increased from 5% to 50%, the size of the crystallized starch particles obtained decreased accordingly, forming large particles or aggregates in some cases. When the concentrations were 5%, 10%, and 15%, the corresponding recrystallized starch sizes were approximately 1.2 μm, 1 μm, and 1.1 μm, respectively. When the concentration increased to 20%, 30%, 40%, and 50%, the corresponding sizes of recrystallized starch decreased significantly, which were 900 nm, 800 nm, 600 nm, and 500 nm, respectively. At the same time, the number of small particles on the aggregates increased significantly.

### (2) DSC Measurement

The thermodynamic properties of the SCG, SCG-5%, SCG-10%, SCG-15%, SCG-20%, SCG-30%, SCG-40%, and SCG-50% samples were determined by DSC-1 (Swiss METTLER-TOLEDO International Trading Co., Ltd.). 4 mg (error range: 4%±5%) of starch sample was placed in an aluminum crucible, ultrapure water was added with a microinjector in a ratio of 1:2 and then sealed. The sealed aluminum crucible was equilibrated at room temperature for 12 h before testing. A temperature scanning range was 25° C. to 130° C., a heating rate was 10° C./min, and an initial gelatinization temperature (Tₒ), a peak gelatinization temperature (Tₚ), an end gelatinization temperature (T_{c}), and a gelatinization enthalpy value (AH) were measured, respectively. The results were shown in Table 1.

TABLE 1
Results of initial gelatinization temperature, peak gelatinization
temperature, end gelatinization temperature (Tₒ, Tₚ, and T_{c})
and enthalpy change (ΔH) of different samples

| Sample | Tₒ (° C.) | Tₚ (° C.) | T_{c} (° C.) | ΔH (J · g⁻¹) |
|---|---|---|---|---|
| Original SCG | 55.49 ± 0.63^{d} | 79.03 ± 0.57^{d} | 88.89 ± 0.21^{f} | 21.71 ± 0.84^{a} |
| SCG-5% | 61.84 ± 0.98^{bcd} | 77.78 ± 0.69^{d} | 96.07 ± 1.24^{e} | 10.97 ± 0.83^{d} |
| SCG-10% | 63.91 ± 1.63^{bc} | 83.25 ± 0.93^{c} | 96.62 ± 1.87^{de} | 17.03 ± 2.62^{bc} |
| SCG-15% | 66.42 ± 3.45^{b} | 83.41 ± 0.36^{c} | 98.26 ± 0.43^{d} | 17.88 ± 0.16^{b} |
| SCG-20% | 60.57 ± 8.57^{bcd} | 84.82 ± 0.36^{c} | 104.44 ± 0.40^{b} | 17.50 ± 1.02^{bc} |
| SCG-30% | 58.86 ± 0.55^{bcd} | 93.53 ± 0.69^{b} | 105.03 ± 0.41^{b} | 14.98 ± 0.89^{c} |
| SCG-40% first | 57.61 ± 1.25^{cd} | 75.94 ± 0.33^{d} | 100.24 ± 0.29^{c} | 5.15 ± 0.39^{c} |
| endothermic peak | | | | |
| SCG-40% second | 105.12 ± 0.35^{a} | 115.77 ± 0.14^{a} | 126.74 ± 0.67^{a} | 5.35 ± 0.12^{e} |
| endothermic peak | | | | |
| SCG-50% | 100.35 ± 0.85^{a} | 114.72 ± 0.48^{a} | 126.62 ± 0.83^{a} | 11.75 ± 1.44^{d} |

Data in the table were expressed as mean±standard deviation (n=3). Different letters in the same column indicated significant differences (p<0.05).

The results in Table 1 showed that after the original SCG (SCG) was debranched by pullulanase, retrogradation at low temperature could induce more hydrogen bond interactions and the formation of more crystal nuclei in the free SCG molecules. Therefore, more crystallized starch could be produced, and there was higher gelatinization enthalpy of the retrograded crystallized starch. The study found that a very interesting experimental phenomenon occurred during the recrystallization of SCG after gelatinization at different concentrations. When the concentration of SCG increased from 5% to 30%, the peak gelatinization temperature (Tₚ) of the crystallized starch obtained after recrystallization showed an increasing trend, from 77.78° C. to 93.53° C. The end gelatinization temperature (T_{c}) also showed an increasing trend, rising from 96.07° C. to 105.03° C. The gelatinization enthalpy values (DH) of crystallized starch samples SCG-5%, SCG-10%, SCG-15%, SCG-20%, and SCG-30% were 10.97 J/g, 17.03 J/g, 17.88 J/g, 17.50 J/g, and 14.98 J/g, respectively. When the concentrations of SCG molecules were 10%, 15%, and 20%, the peak gelatinization temperatures (Tₚ) of the formed crystallized starch were 83.25° C., 83.41° C., and 84.82° C., respectively, and the gelatinization enthalpy values (DH) were 17.03 J/g, 17.88 J/g, and 17.50 J/g, respectively. There was little difference in the peak gelatinization temperature (Tₚ) and gelatinization enthalpy (DH) of these three crystallized starch samples. According to the DSC data, at a concentration of 20%, heat-resistant crystallized starch appeared, and the maximum gelatinization temperature of some crystals was 104.44° C. When the concentration of SCG was 40% and 50%, the crystallized starch obtained an interesting result: the crystallized starch obtained at the concentration of 40% showed two endothermic peaks. The first endothermic peak was below 100° C., the gelatinization temperature range (T_{c} to Tₒ) was 57.61° C. to 100.24° C., and the gelatinization enthalpy value was 5.15 J/g. The second endothermic peak was above 100° C., the gelatinization temperature range (T_{c} to Tₒ) was 105.12° C. to 126.74° C., and the gelatinization enthalpy value was 5.35 J/g. The crystallized starch obtained at 50% concentration had a gelatinization temperature above 100° C., a gelatinization temperature range (T_{c} to Tₒ) of 100.35° C. to 126.62° C., and a gelatinization enthalpy value of 11.75 J/g. DSC results showed that the weak crystallization of crystallized starch at a concentration of 40% could transform into heat-resistant crystals at a higher concentration. The crystallized starch obtained at 50% concentration had a gelatinization temperature range (T_{c} to Tₒ) of 100.35° C. to 126.62° C., such that the crystallized starch obtained at 50% concentration was heat-resistant crystallized starch.

### (3) XRD Analysis

The test was conducted using an XRD instrument. The test parameters included a divergence gap of 0.38 mm, a generator voltage of 40 kV, and a Cu Kα radiation tube current of 30 mA (λ=1.5405 nm). All experiments were conducted at room temperature (about 25° C.), with a scanning area of 4° to 40° (2θ), a step size of 0.02, and an integration time of 0.1 s. The relative crystallinity of the samples SCG, SCG-5%, SCG-10%, SCG-15%, SCG-20%, SCG-30%, SCG-40%, and SCG-50% was calculated based on the peak baseline and area of the diffraction pattern using JADE software. The relative crystallinity (%) was determined as follows:

$$Relative crystallinity ( \% ) = peak area \div total area \times 100 \%$$

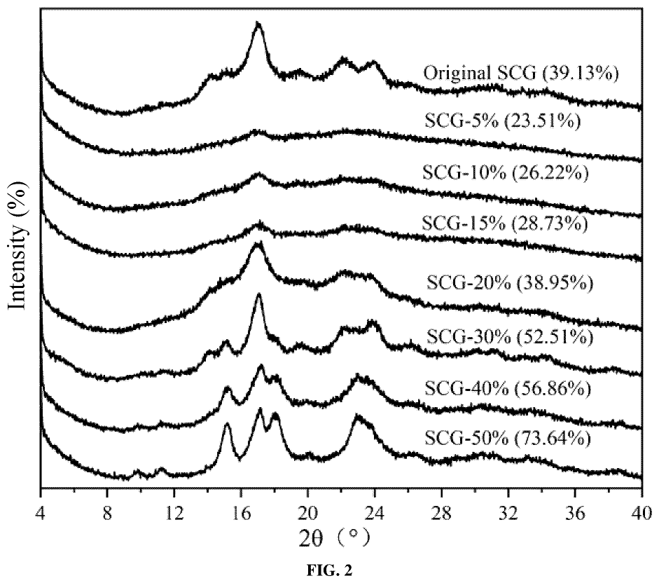

The results in FIG. 2 showed that original SCG (SCG) exhibited a typical B-type crystal structure, with peaks at 2θ=17.1°, 22.5°, and 24.3°, and a relative crystallinity of 39.13%. Since the crystallized starch regenerated by SCG at low temperature during the drying had experienced further crystal growth and perfection in the 50° C. environment, there was a relatively high degree of crystallinity. For SCG at low concentrations of 5%, 10%, and 15%, the crystallized starch formed by recrystallization after gelatinization showed type B crystals. However, their diffraction peaks at 2θ=22.5° and 24.3° were not obvious, and the relative crystallinity values were 23.51%, 26.22%, and 28.73%, respectively. As the concentration increased to 20% and 30%, the B-type crystalline diffraction characteristic peaks of the crystallized starch obtained by the recrystallization after gelatinization appeared, with crystallinity of 38.95% and 52.51%, respectively. When the concentration of SCG reached 40% and 50%, the diffraction peak of the crystallized starch formed after SCG was gelatinized changed from type B at low concentration to typical type-A crystallization peak, with crystallinity of 56.86% and 73.64%, respectively. Moreover, the diffraction double peaks of crystallized starch formed at 50% concentration were more obvious than those at 40% concentration.

### (4) Fourier Transform Infrared Spectroscopy

The molecular structures of the SCG, SCG-5%, SCG-10%, SCG-15%, SCG-20%, SCG-30%, SCG-40%, and SCG-50% samples were detected by FTIR using NEXUS-870 Spectrometer (Thermo Fisher Scientific, USA) combined with an attenuated total reflectance (ATR) accessory. The detection had a scanning wave number range of (400-4000) cm⁻¹ and a resolution of 4 cm⁻¹.

### (5) Raman Spectroscopy Measurement (Raman)

The Raman analysis of the SCG, SCG-5%, SCG-10%, SCG-15%, SCG-20%, SCG-30%, SCG-40%, and SCG-50% samples was performed using DXR2xi microscope Raman imaging spectrometer (Thermo Fisher Scientific, USA). A 532 nm diode laser was used. The full width at half maximum (FWHM) of the peak at 480 cm⁻¹ was calculated using ORIGIN 2023 version software.

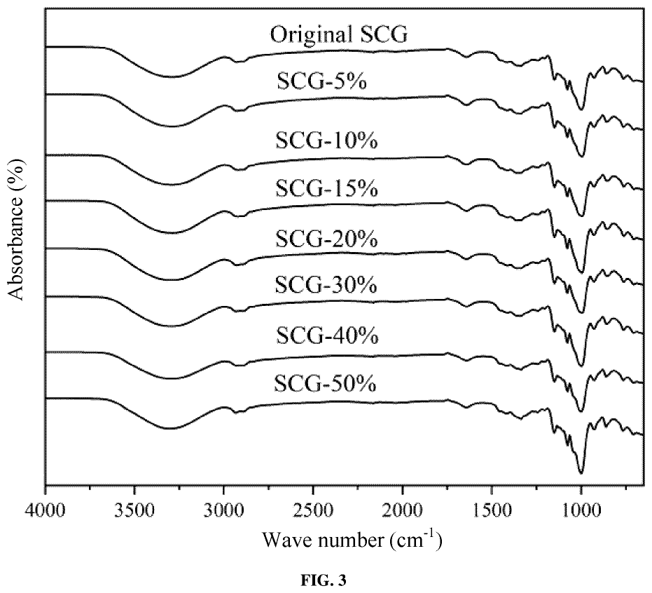

The FTIR spectra and 1047/1022 cm⁻¹ ratio of original SCG and crystallized starch after gelatinization at different concentrations were shown in FIG. 3 and Table 2.

TABLE 2
Infrared spectrum and Raman spectrum analysis parameters of
original SCG (SCG) and crystallized starch obtained at different
concentrations (5%, 10%, 15%, 20%, 30%, 40%, and 50%)

| Sample | R_{1047/1022} | FWHM (480 cm⁻¹) |
|---|---|---|
| Original SCG | 0.757 ± 0.016^{f} | 15.91 ± 0.09^{a} |
| SCG-5% | 0.812 ± 0.004^{e} | 15.64 ± 0.08^{b} |
| SCG-10% | 0.827 ± 0.013^{e} | 15.51 ± 0.03^{b} |
| SCG-15% | 0.852 ± 0.007^{d} | 15.42 ± 0.23^{b} |
| SCG-20% | 0.869 ± 0.008^{d} | 14.21 ± 0.21^{c} |
| SCG-30% | 0.911 ± 0.004^{c} | 13.81 ± 0.06^{d} |
| SCG-40% | 0.943 ± 0.008^{b} | 13.52 ± 0.08^{e} |
| SCG-50% | 0.972 ± 0.009^{a} | 13.09 ± 0.06^{f} |

The ratio R_{1047/1022} represented the intensity ratio at 1,047 and 1,022 cm⁻¹, and the FWHM (480 cm⁻¹) represented the FWHM at 480 cm⁻¹. Data in the table were expressed as mean±standard deviation (n=3). Different letters in the same column indicated significant differences (p<0.05).

FIG. 3 and Table 2 showed that compared with the original SCG starch, the infrared spectrum of crystallized starch exhibited certain differences. The band at 3,450 cm⁻¹ was significantly stronger than that of the original SCG, indicating that as the initial concentration of SCG increased, a hydrogen bond intensity between the crystallized starch molecules gradually increased. The intensity ratio at 1047/1022 cm⁻¹ (R_{1047/1022}) was an effective index to evaluate the short-range order of starch molecules. After the SCG underwent gelatinization, the ratio R_{1047/1022} (0.812 to 0.972) of the crystallized starch formed was significantly higher than that of the original SCG (0.757). This indicated that the internal linear short-chain molecules of the SCG-5%, SCG-10%, SCG-15%, SCG-20%, SCG-30%, SCG-40%, and SCG-50% samples were highly ordered. Compared with the ratio R1047 1022 of recrystallized starch samples SCG-5%, SCG-10%, and SCG-15%: when the concentration reached above 20%, the obtained recrystallized starch samples SCG-20%, SCG-30%, SCG-40%, and SCG-50% had larger ratios R1047 1022, which were 0.869, 0.911, 0.943, and 0.972, respectively. The ratio of recrystallized starch obtained at concentrations of 40% and 50% was nearly twice higher than that of the original SCG, indicating that the hydrogen bonding interactions between SCG molecules became stronger as the concentration increased. Therefore, the resulting recrystallized starch showed a more compact internal crystalline structure.

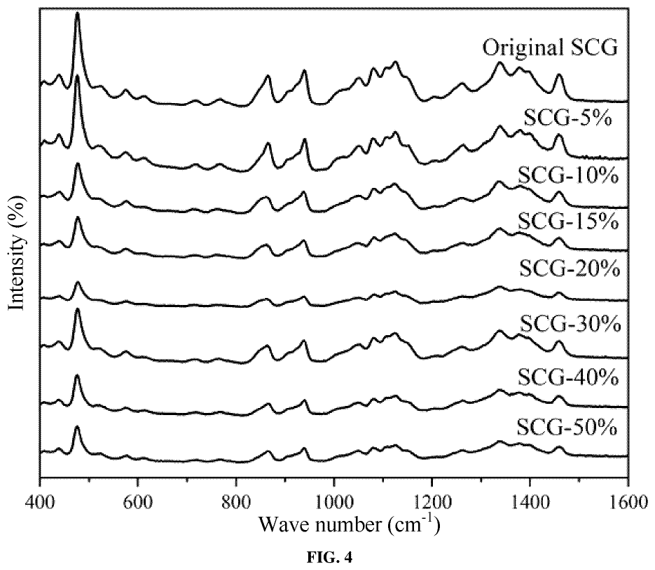

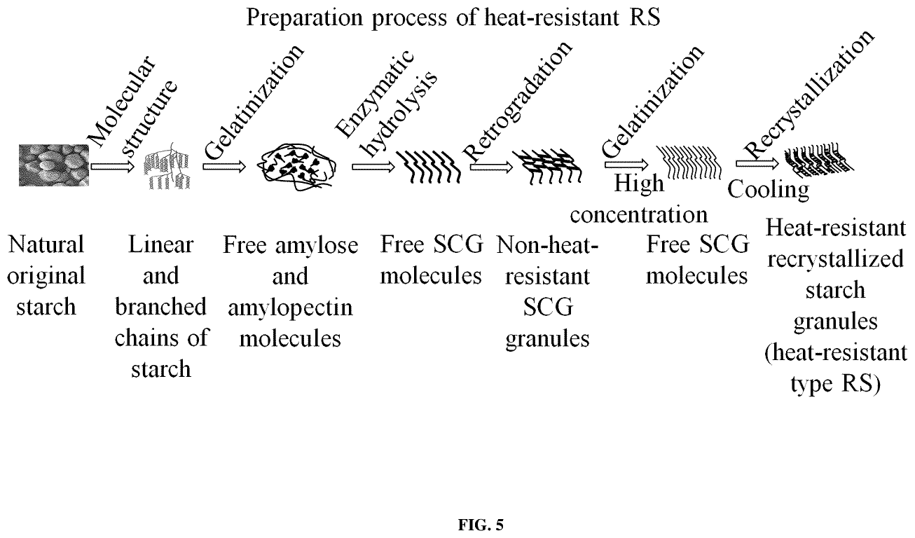

The Raman spectra of crystallized starch samples obtained at different concentrations were shown in FIG. 4.

The results in FIG. 4 showed that the absorption peak positions observed for original SCG and crystallized starch at different concentrations were almost the same, but their intensities varied. Generally, a maximum FWHM at 480 cm⁻¹ could characterize the short-range ordering of starch molecules. A smaller FWHM value meant a more ordered crystal structure. The FWHM at 480 cm⁻¹ was shown in Table 2. The FWHM of original SCG (15.91) of the control sample was higher than that of crystallized starch (13.09 to 15.64), proving that the short-range order of the crystallized starch re-formed after gelatinization and recrystallization of SCG was stronger than that of the original SCG. As the concentration of SCG increased, the FWHM of crystallized starch samples gradually decreased, and the short-range order of crystallized starch was positively correlated with the concentration of SCG. As shown in Table 2, the FWHM values of SCG-5% (15.64), SCG-10% (15.51), and SCG-15% (15.42) were similar. The corresponding relative crystallinity values of these three crystallized starch samples were 23.51%, 26.22%, and 28.73%, respectively, indicating that there were similar changing trends of long-range order and short-range order. The strong hydrogen bonding interactions of SCG molecules participated in the formation of crystallized starch and increased the relative crystallinity of starch, which in turn led to an increase in the degree of short-range order. These results indicated that SCG molecules formed a more ordered molecular structure during the recrystallization. At 480 cm⁻¹, the FWHM of crystallized starch decreased as the SCG concentration increased from 5% to 50%, indicating that a certain concentration and amount of SCG could form an ordered crystallized starch structure. In summary, the enhancement of starch chain molecular interactions and the rearrangement of the double helix structure enhanced the crystal regularity of SCG samples after gelatinization and recrystallization. Thus, a more ordered starch crystal structure was formed and the RS content was increased.

### (6) Simulated In Vitro Digestion Test

3 g of trypsin was dispersed in 20 mL of deionized water and vortexed for 10 min, 15 mL of a resulting supernatant was transferred to a centrifuge tube, and 1.1 mL of α-glucosidase was added to obtain an enzyme solution. The above enzyme solution needed to be prepared before each use. 200 mg each of SCG, SCG-5%, SCG-10%, SCG-15%, SCG-20%, SCG-30%, SCG-40%, and SCG-50% samples and 18 mL of pH=5.20 acetate buffer were added into a centrifuge tube, 20 glass beads and 2 mL of mixed enzyme solution were added to each tube, the centrifuge tube was placed in a 37° C. shaking water bath for enzymatic hydrolysis and digestion; where different starch samples were digested for 0 min, 20 min, and 120 min separately. At each designated digestion time, 0.1 mL of a resulting hydrolyzate sample was removed from each centrifuge tube and mixed with 0.9 mL of a 90% ethanol solution. A hydrolyzed glucose content in the supernatant after centrifugation was determined using K-GLUC reagent. At different digestion times t=0 min (G₀), t=20 min (G₂₀), and t=120 min (G₁₂₀), RDS (rapidly digestible starch), SDS (slowly digestible starch), and RS (resistance starch) contents were calculated. The results were calculated in terms of RS sample mass(S) and were expressed as:

$$RDS ( \% ) = ( {G}_{20} - {G}_{0} ) \times 0.9 \times 100 \div S \\ SDS ( \% ) = ( {G}_{120} - {G}_{20} ) \times 0.9 \times 100 \div S \\ RS ( \% ) = 1 - RDS - SDS$$

0.9 was a stoichiometric constant of starch with glucose content.

The RDS, SDS, and RS contents of original SCG samples and crystallized starch samples at different concentrations were shown in Table 3.

TABLE 3
RDS, SDS, and RS contents of original SCG and crystallized
starch obtained at different concentrations (5%,
10%, 15%, 20%, 30%, 40%, and 50%)

| Sample | RDS (%) | SDS (%) | RS (%) |
|---|---|---|---|
| Original SCG | 81.13 ± 1.06^{a} | 2.72 ± 0.76^{d} | 16.16 ± 0.31^{g} |
| SCG-5% | 62.34 ± 0.22^{b} | 6.89 ± 0.58^{c} | 30.78 ± 0.79^{f} |
| SCG-10% | 42.66 ± 1.17^{c} | 13.99 ± 0.58^{a} | 43.36 ± 1.75^{c} |
| SCG-15% | 37.89 ± 0.98^{d} | 4.02 ± 0.79^{d} | 58.09 ± 0.19^{d} |
| SCG-20% | 24.24 ± 0.06^{e} | 14.82 ± 0.93^{a} | 60.95 ± 0.86^{c} |
| SCG-30% | 23.88 ± 0.22^{e} | 14.11 ± 0.82^{a} | 62.01 ± 0.61^{bc} |
| SCG-40% | 23.24 ± 0.23^{e} | 12.84 ± 0.91^{a} | 63.93 ± 1.15^{b} |
| SCG-50% | 18.70 ± 0.22^{f} | 9.21 ± 1.08^{b} | 72.08 ± 0.86^{a} |

Data in the table were expressed as mean±standard deviation (n=3). Different letters in the same column indicated significant differences (p<0.05).

About 81% of the starch in the original SCG was rapidly hydrolyzed and digested by digestive enzymes within 20 min. As the concentration of SCG increased, the RDS content of crystallized starch showed a decreasing trend. The RDS content of crystallized starch obtained at 5% concentration was 62.34%, while the RDS content of crystallized starch obtained at 10% concentration was 42.66%, showing a decrease of nearly 20%. The corresponding RDS contents of 15%, 20%, 30%, 40%, and 50% were 37.89%, 24.24%, 23.88%, 23.24%, and 18.70%, respectively, thus significantly reducing the RDS content compared with the original SCG (81.13%).

There was a significant difference in the in vitro digestibility of original SCG (81.13%) and crystallized starch samples at other concentrations before and after gelatinization by concentration changes. As the concentration increased, the gelatinized crystallized starch sample had higher resistance to enzymatic hydrolysis than that of the original SCG sample (81.13%). It was worth noting that after gelatinization and recrystallization, the degree of hydrolysis of the modified crystallized starch sample was significantly reduced. This was because gelatinization and recrystallization significantly increased the SDS content and RS content levels of crystallized starch, with the RS content reaching a maximum of 72.08%.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A preparation method of a heat-resistant resistant starch (RS), comprising the following steps:
preparing a short chain glucan (SCG) into a SCG mixed dispersion with a mass volume concentration of 20% to 100%, and conducting gelatinization to obtain a transparent SCG molecule solution; naturally cooling the transparent SCG molecule solution to allow recrystallization until the transparent SCG molecule solution is cooled to room temperature to obtain a crystallized starch; and freeze-drying the crystallized starch to obtain the heat-resistant RS.

2. The preparation method according to claim 1, wherein a solvent of the SCG mixed dispersion is water.

3. The preparation method according to claim 1, wherein the gelatinization is conducted at 100° C. to 120° C. for 1 min to 30 min.

4. The preparation method according to claim 1, wherein a preparation process of the SCG comprises the following steps:
(1) stirring a starch milk with a mass volume concentration of 10% to 20% to allow gelatinization to obtain a starch paste;
(2) mixing the starch paste with an enzyme to allow enzymatic debranching to obtain an enzymatic mixture;
(3) subjecting the enzymatic mixture to first centrifugation at 3,000 rpm to 4,000 rpm for 0.5 min to 1.5 min to obtain a supernatant 1, subjecting the supernatant 1 to enzyme deactivation to obtain an enzyme-deactivated mixture, and subjecting the enzyme-deactivated mixture to second centrifugation at 3,000 rpm to 4,000 rpm for 0.5 min to 1.5 min to obtain a supernatant 2; and
(4) subjecting the supernatant 2 to recrystallization and retrogradation at 2° C. to 6° C. for 8 h to 16 h, centrifuging to discard a resulting supernatant, and then drying a remaining product to obtain the SCG.

5. The preparation method according to claim 4, wherein a solvent of the SCG mixed dispersion is water.

6. The preparation method according to claim 4, wherein the gelatinization is conducted at 100° C. to 120° C. for 1 min to 30 min.

7. The preparation method according to claim 4, wherein the gelatinization in step (1) is conducted at 95° C. to 125° C. for 25 min to 35 min.

8. The preparation method according to claim 4, wherein the starch milk in step (1) has a pH value of 4.5 to 5.0; and the starch milk is prepared by dispersing a starch in a phosphate-buffered saline (PBS).

9. The preparation method according to claim 4, wherein the enzyme in step (2) is selected from the group consisting of pullulanase and isoamylase; the enzyme has an activity of 6,000 new pullulanase unit novozymes (NPUN) to 7,000 NPUN; the starch paste and the enzyme are at a mass-to-volume ratio of 100 g: (1-5) mL; and the enzymatic debranching is conducted at 50° C. to 60° C. for 22 h to 26 h.

10. The preparation method according to claim 4, wherein the first centrifugation and the second centrifugation in step (4) each are conducted at 4,000 rpm to 6,000 rpm for 5 min to 15 min.

11. The preparation method according to claim 4, wherein the starch is one or more selected from the group consisting of a waxy corn starch, a common corn starch, a potato starch, a pea starch, and a tapioca starch.

12. A heat-resistant RS prepared by the preparation method according to claim 1.

13. A heat-resistant RS prepared by the preparation method according to claim 2.

14. A heat-resistant RS prepared by the preparation method according to claim 3.

15. A heat-resistant RS prepared by the preparation method according to claim 4.

16. A heat-resistant RS prepared by the preparation method according to claim 7.

17. A heat-resistant RS prepared by the preparation method according to claim 8.

18. A heat-resistant RS prepared by the preparation method according to claim 9.

19. A heat-resistant RS prepared by the preparation method according to claim 10.

20. A heat-resistant RS prepared by the preparation method according to claim 11.
